(19) United States
(12) Patent Application Publication
(10) Pub. No.: US 2023/0021563 A1
(43) Pub. Date: Jan. 26, 2023

(54) FEDERATED DATA STANDARDIZATION USING DATA PRIVACY TECHNIQUES

(71) Applicant: International Business Machines Corporation, Armonk, NY (US)

(72) Inventors: Ramasuri Narayanam, Bangalore (IN); Hima Patel, Bengaluru (IN); Sameep Mehta, Bangalore (IN)

(21) Appl. No.: 17/384,180

(22) Filed: Jul. 23, 2021

(51) Int. Cl. G06N 20/00; G06K 9/62; G06F 21/62

(52) U.S. Cl. CPC G06N 20/00; G06K 9/6262; G06F 21/6245; G06K 9/6218

(57) ABSTRACT

Methods, systems, and computer program products for federated data standardization using data privacy techniques are provided herein. A computer-implemented method includes obtaining multiple datasets from multiple clients in accordance with one or more data privacy techniques; determining one or more similar data columns across at least a portion of the multiple datasets; generating one or more column labels for the one or more similar data columns; standardizing at least a portion of data within the one or more similar data columns by processing the one or more generated column labels using at least one federated learning technique; and performing one or more automated actions based at least in part on results of the standardizing of the at least a portion of data within the one or more similar data columns.

### BACKGROUND

The present application generally relates to information technology and, more particularly, to data management techniques. More specifically, consider the setting of federated learning (FL), wherein different users possess private data which cannot be shared with other users due to privacy constraints. In such a setting, assume the implementation of a machine learning task such as training a machine learning algorithm across various decentralized devices, each holding sensitive or otherwise private data. Further, such a task may include rendering data consistent across the different devices, thereby enabling accurate execution of the machine learning algorithm. However, challenges exist with respect to maintaining data privacy across the different devices.

### SUMMARY

In one embodiment of the present invention, techniques for federated data standardization using data privacy techniques are provided. An exemplary computer-implemented method can include obtaining multiple datasets from multiple clients in accordance with one or more data privacy techniques, determining one or more similar data columns across at least a portion of the multiple datasets, and generating one or more column labels for the one or more similar data columns. The method can also include standardizing at least a portion of data within the one or more similar data columns by processing the one or more generated column labels using at least one federated learning technique, and performing one or more automated actions based at least in part on results of the standardizing of the at least a portion of data within the one or more similar data columns.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2 is a flow diagram illustrating techniques according to an embodiment of the invention;

FIG. 3 is a system diagram of an exemplary computer system on which at least one embodiment of the invention can be implemented;

FIG. 4 depicts a cloud computing environment according to an embodiment of the present invention; and

FIG. 5 depicts abstraction model layers according to an embodiment of the present invention.

### DETAILED DESCRIPTION

As described herein, an embodiment of the present invention includes federated data standardization using data privacy techniques. One or more embodiments include, in a federated learning setting, standardizing column values and column labels and/or names of participating clients' private data (for example, for supervised machine learning settings) by learning a mapping of similar columns across different clients' data. As further detailed herein, such an embodiment can include standardizing column labels and/or names of the clients' data by computing one or more feature labels and embedding the computed feature label(s) to learn feature name standardization across different clients' data. As used herein, “embedding” refers to a method of deriving a numerical vector representation of one or more labels such that the numerical vector can further be used in building a machine learning model for feature name standardization. Additionally, as used above and further herein, features refer to columns of datasets owned by different clients. A purpose of feature name standardization can include deriving the same feature name across two or more clients (in a privacy-preserving manner) such that the clients would have and/or use the same label. Similarly, another purpose of column value standardization can include deriving the same value standardization across the two or more clients.

Accordingly, one or more embodiments include using federated learning techniques to standardize clients' private data without violating one or more client and/or data privacy constraints. Such an embodiment includes determining similar data columns across various clients' data, computing column values and column labels and/or names for at least portions of the similar data columns. Additionally, such an embodiment includes utilizing at least a portion of the column values and column labels and/or names for standardizing data across the various clients using one or more federated learning settings without violating one or more client privacy constraints. By way of illustration an example privacy constraint might include a principle that clients do not want to share column data or labels directly with any other client or a central server of a given federated learning system. Rather, each client can share, for example, some higher-order statistics of their data (such as derived embeddings of each column data, for instance) with the server.

At least one embodiment can include implementation in contexts of data standardization before any machine learning models are built in federated settings. In such settings, clients typically cannot share data across nodes, and as such, there is no global visibility of data. In the absence of such visibility, it is important to ensure, for example, that column X from a dataset in client1 corresponds to column Y from a dataset in client2; otherwise the model learning becomes increasingly challenging.

In other example contexts, many organizations adopt hybrid cloud infrastructure, and the orchestration by organizations associated with such infrastructure facilitates access hybrid data as well as analysis of such data. However, compliance, security, data privacy, and network performance often make hybrid data difficult for the organizations to move together (or pool) across different cloud environments. To address such technical challenges associated with hybrid data environments, a federated learning paradigm (which, for example, does not require data pooling) can be introduced in accordance with one or more embodiments.

As detailed herein, such an embodiment includes feature label standardization, which can include learning and/or mapping similar columns across different clients' data and embedding one or more feature labels into such client data to facilitate learning of feature name standardization(s) across the different clients.

Additionally, at least one embodiment includes learning and/or identifying similar columns across different sets of client data using graph node anchoring techniques. Such an embodiment can include, at each individual client, constructing a graph (G_i) using at least a portion of the client's available private data (i). In constructing such a graph, the nodes of the graph represent the columns in the client's dataset, and edge weights represent correlations among pairs of the columns.

Also, one or more embodiments include determining edge weights between a pair of columns (C1, C2) in a graph (G_i). Such a determination can include repeating the following steps for different values of k and using the best k value to derive the edge weight of (C1, C2). The first such step includes computing k clusters and/or groups using the data in column C1 and referring to that set of k clusters/groups as D1. Similarly, a related step includes computing k clusters and/or groups using the data in column C2 and referring to that set of k clusters/groups as D2. In at least one embodiment, such clusters and/or groups within each column are computed using one or more clustering algorithms (e.g., a K-means clustering algorithm) based on the similarity of the values in the column.

The second such step includes constructing a graph (S), wherein the set of nodes in graph (S) include the set of clusters/groups in D1 and D2. Accordingly, there would be a total of 2 k nodes in graph (S), and the edges and corresponding weights of these edges in graph (S) can be designed as follows. For each group in D1 and D2, the word embedding of each data value/point is computed. By way of illustration, because each client cannot share its own column's data with the central server, each client partitions each of its columns into k groups of data points. For each group (g1) from column 1, one or more embodiments include computing a word embedding vector, which can be computed as follows. Consider, for example, that the group g1 contains m data points. Using an algorithm such as, e.g., the word2vec algorithm, such an embodiment includes computing an embedding vector for each data point in the group g1. Then, to compute an embedding vector for the group g1 itself, such an embodiment includes taking the average of the word embedding vectors of data points in g1. Note that these word embeddings possess similar information as in the original data points but in a different feature space, such that the privacy of the clients is not breached by sharing these embedding vectors.

Also, from each group (g1) in D1 to each group (g2) in D2, the average distance between word embeddings (of g1 and g2) is computed. In at least one embodiment, the distance between two groups (e.g., g1 and g2) can be computed using one or more distance metrics such as Euclidean distance (L2 norm). The smaller the computed distance, the more similarity exists between these two groups of data. Accordingly, the weight of the edge between these two groups (g1, g2) is inversely proportional to the computed average distance therebetween. Subsequently, the maximum weight matching of graph (S) can be determined to identify the most similar pairs of groups between D1 and D2, wherein the weight of this matching represents the similarity between the two columns C1 and C2. The intuition behind “maximum weight matching” includes selecting a set of edges with maximum weight from the given graph such that each node is covered or incident on at most one edge in the matching. In at least one embodiment, one or more polynomial time algorithms can be used to determine maximum weight matching of a given graph. Further, in one or more embodiments, graph (G_i) can be shared and/or output to a server by the client in question.

Additionally, in at least one embodiment, at the server, graph node anchoring (implemented to learn and/or identify similar columns across different sets of client data) can include the following. Upon receiving k graphs (G_1, G_2, . . . , G_K) from the given set of clients, the server solves a graph node anchoring problem wherein a function is learned to map nodes from one graph to nodes of at least one other graph by leveraging the graph connectivity structure. As used herein, graph connectivity structure refers to the structure of a graph (e.g., G_i) shared by a client (e.g., client i) with the server. Typically, the structure of the graph refers to the set of edges among the nodes along with how the nodes and/or edges are connected with each other. Additionally, as detailed herein, graph connectivity structure can be leveraged to learn a mapping of the nodes in the graph (e.g., G_i) to the nodes in a different graph (e.g., graph G_j). To accomplish this, potential properties of the connectivity structure that can be leveraged can include, for example, the degree of each node, the average distance of each node to other nodes, egonet (i.e., the 1-hop neighborhood of each node), etc. Note that in one or more example embodiments, the clients/nodes would contain similar data regarding a particular task (e.g., employee details of different office locations, etc.).

As also detailed herein, one or more embodiments include learning feature name standardization across different clients by utilizing feature label embedding. In such an embodiment, the following protocol can be executed for each column. At each individual client, by making use of the values in each column, a machine learning model is trained to predict the name of the column and its corresponding embedding vector. By way of example, one or more embodiments include attempting to determine a possible descriptive name of a column by making use of the values in that column itself. At least one machine learning model can be learned to determine such a name for each column, and the corresponding embedding vector can be determined using an algorithm such as, e.g., the word2vec algorithm. Such column values can often include “short text,” and short text clustering techniques can be used to generate and/or determine one or more clusters. As used herein, short text refers to one word or a small collection of words (as opposed to one or more sentences, for example). Because column names are often formed with one word or a small number of words, such names often qualify to be “short texts.” Such clusters can then be used to derive one or more meaningful cluster labels.

At least one embodiment can then include deriving one or more word embeddings for each of the cluster labels and aggregating the word embeddings to derive and/or generate a single unified label embedding vector. Note that each cluster can include a collection of similar-looking column labels. For each column label (L) in a given cluster (C), such an embodiment includes using an algorithm such as, for example, the word2vec embedding algorithm, to derive an embedding vector for the label (L). Then, by using these embedding vectors for the labels in cluster (C), such an embodiment can include computing an average of all of these embedding vectors to determine an embedding vector for the cluster (C) itself. Further, in such an embodiment, each client can then share and/or output the derived label embedding vector (e_i) with a server.

At the server, in one or more embodiments, upon receiving the K embedding vectors (e_1, e_2, . . . , e_K) from at least a portion of the clients, a computation is performed to derive a single label embedding vector. By way merely of example, such a computation can include aggregating all of the embedding vectors.

As also detailed herein, feature values standardization can include agreement on column mapping across clients, agreement on column output, and standardization using at least one program by example. In one or more embodiments, such a program by example can include a representative table to illustrate how the embedding vector that represents the column label of each client should be given a label in plain English, and that this English label is thereby consistent across all clients having the same column.

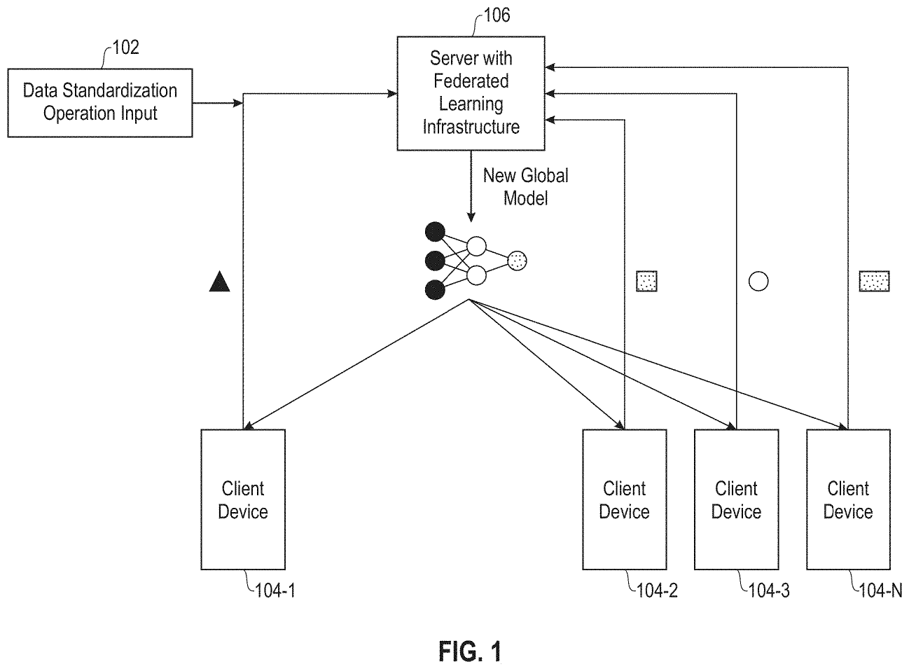

FIG. 1 is a diagram illustrating system architecture, according to an embodiment of the invention. By way of illustration, FIG. 1 depicts data standardization operation input 102, which can include, for example, identification of a particular data standardization operation selected by at least one data scientist and/or other user. Such input 102 is provided to server 106. Also depicted in FIG. 1 are client devices 104-1, 104-2, 104-3, . . . 104-N, collectively referred to herein as client devices 104. Metadata are shared (without violating one or more privacy constraints) by client devices 104 to server 106, and server 106, using federated learning infrastructure, executes the data standardization operation from input 102 using at least a portion of the metadata provided by client devices 104. Subsequently, based at least in part on the execution of the data standardization operation, server 106 outputs standardized versions of data, residing in each client device 104, to the given client devices 104, while also preserving data privacy in accordance with one or more privacy constraints. Regarding the arrow from the server 106 that indicates “new global model,” this refers to the model learned at the server by making use of the inputs and/or information shared by the client devices 104. Because clients cannot share the data directly, the clients can only share some higher-order statistics (e.g., such as embedding vectors). The server 106 makes use of these informative embedding vectors to learn a model at the server-side to derive and/or generate a global model that has collective information from the client devices 104. Additionally, the different shapes illustrated in FIG. 1 in connection with the lines from the client devices 104 to the server 106 merely indicate that the information shared by each client device 104 to the sever 106 (for the data standardization problem) is different.

The client devices 104 illustrated in FIG. 1 and otherwise detailed herein may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The client devices 104 in some embodiments may also comprise respective computers associated with a particular company, organization or other enterprise. Numerous other operating scenarios involving a wide variety of different types and arrangements of processing devices and networks are possible, as will be appreciated by those skilled in the art.

Further, it is to be appreciated that the term “client” in this context and elsewhere herein is intended to be broadly construed so as to encompass, for example, human, hardware, software or firmware entities, as well as various combinations of such entities.

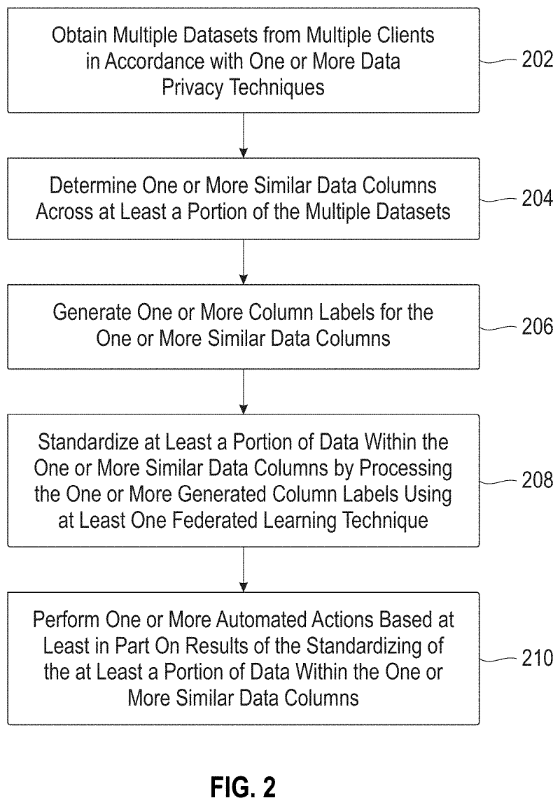

FIG. 2 is a flow diagram illustrating techniques according to an embodiment of the present invention. Step 202 includes obtaining multiple datasets from multiple clients in accordance with one or more data privacy techniques. Step 204 includes determining one or more similar data columns across at least a portion of the multiple datasets. In at least one embodiment, determining similar data columns includes identifying the one or more similar data columns across at least a portion of the multiple datasets using one or more graph node anchoring techniques. In such an embodiment, using one or more graph node anchoring techniques includes, for each of the multiple datasets, constructing a graph using at least a portion of available sensitive data contained therein, and wherein in constructing the graph, each node of the graph represents a column in the given dataset, and each edge weight represents a correlation among pairs of columns in the given dataset. Additionally, using one or more graph node anchoring techniques can include mapping one or more nodes from one of the constructed graphs to one or more nodes of at least one other of the constructed graphs by leveraging graph connectivity structure information.

Step 206 includes generating one or more column labels for the one or more similar data columns. Step 208 includes standardizing at least a portion of data within the one or more similar data columns by processing the one or more generated column labels using at least one federated learning technique. In at least one embodiment, processing the one or more generated column labels using at least one federated learning technique includes learning feature name standardization across at least a portion of the multiple datasets by utilizing one or more feature label embedding techniques and based at least in part on the one or more generated column labels. In such an embodiment, learning feature name standardization across at least a portion of the multiple datasets includes training at least one machine learning model, using values in at least a portion of the one or more similar data columns, to predict a name of the given data column and at least one corresponding embedding vector of the given data column. By way of example, the values can include text, and training the at least one machine learning model can include using one or more text clustering techniques to generate one or more clusters among the at least a portion of the one or more similar data columns.

Further, at least one embodiment can also include determining one or more cluster labels based at least in part on the one or more generated clusters, deriving one or more word embeddings for each of the one or more cluster labels, and generating a single unified label embedding vector based at least in part on aggregating the derived word embeddings.

Step 210 includes performing one or more automated actions based at least in part on results of the standardizing of the at least a portion of data within the one or more similar data columns. In at least one embodiment, performing one or more automated actions includes outputting corresponding portions of the standardized data to the respective ones of the multiple clients. Additionally or alternatively, one or more embodiments can include generating and/or providing software implementing the techniques depicted in FIG. 2 as a service in a cloud environment.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

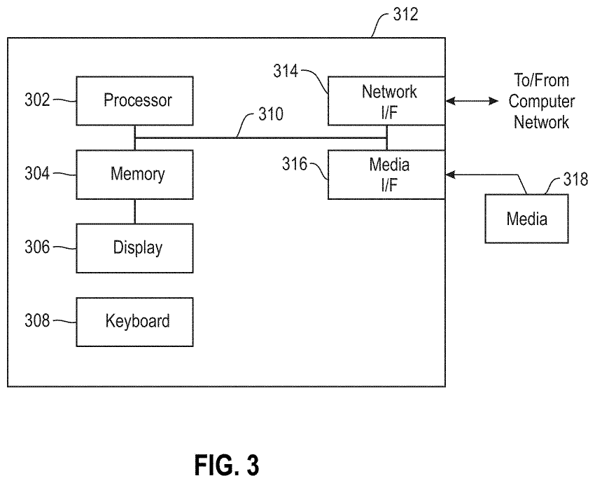

Additionally, an embodiment of the present invention can make use of software running on a computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

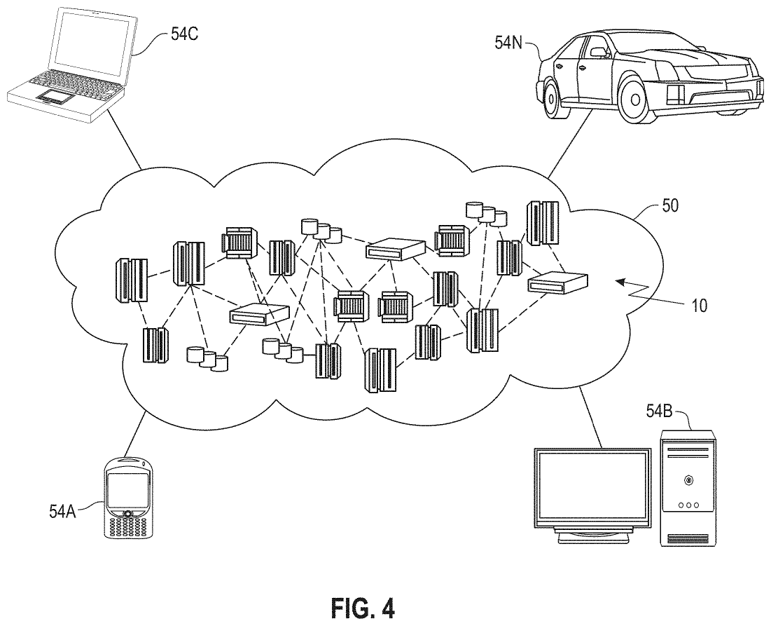

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

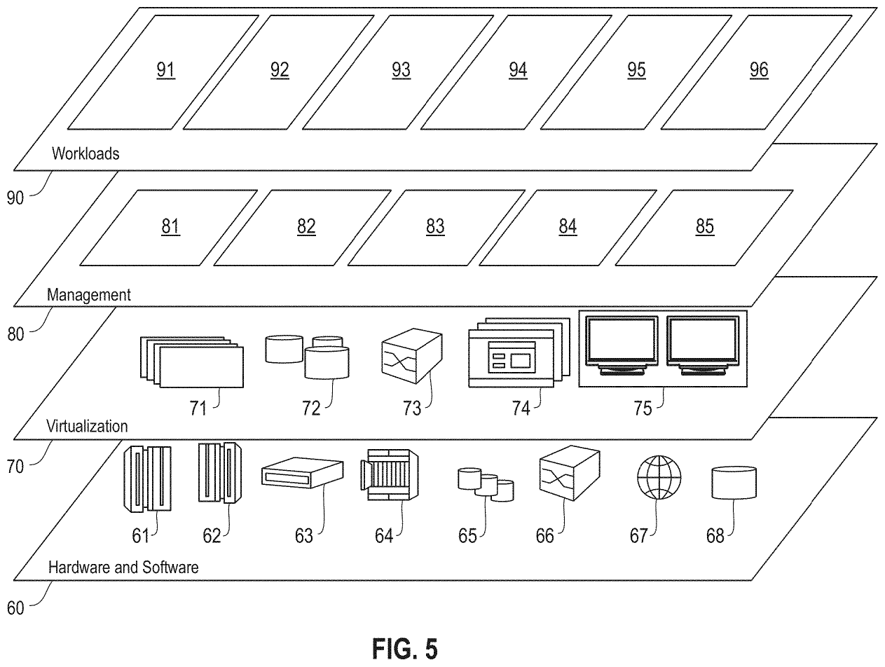

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and federated data standardization 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, automating federated data standardization using data privacy techniques.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining multiple datasets from multiple clients in accordance with one or more data privacy techniques;
determining one or more similar data columns across at least a portion of the multiple datasets;
generating one or more column labels for the one or more similar data columns;
standardizing at least a portion of data within the one or more similar data columns by processing the one or more generated column labels using at least one federated learning technique; and
performing one or more automated actions based at least in part on results of the standardizing of the at least a portion of data within the one or more similar data columns;
wherein the method is carried out by at least one computing device.

2. The computer-implemented method of claim 1, wherein determining similar data columns comprises identifying the one or more similar data columns across at least a portion of the multiple datasets using one or more graph node anchoring techniques.

3. The computer-implemented method of claim 2, wherein using one or more graph node anchoring techniques comprises, for each of the multiple datasets, constructing a graph using at least a portion of available sensitive data contained therein, and wherein in constructing the graph, each node of the graph represents a column in the given dataset, and each edge weight represents a correlation among pairs of columns in the given dataset.

4. The computer-implemented method of claim 3, wherein using one or more graph node anchoring techniques comprises mapping one or more nodes from one of the constructed graphs to one or more nodes of at least one other of the constructed graphs by leveraging graph connectivity structure information.

5. The computer-implemented method of claim 1, wherein processing the one or more generated column labels using at least one federated learning technique comprises learning feature name standardization across at least a portion of the multiple datasets by utilizing one or more feature label embedding techniques and based at least in part on the one or more generated column labels.

6. The computer-implemented method of claim 5, wherein learning feature name standardization across at least a portion of the multiple datasets comprises training at least one machine learning model, using values in at least a portion of the one or more similar data columns, to predict a name of the given data column and at least one corresponding embedding vector of the given data column.

7. The computer-implemented method of claim 6, wherein the values comprise text, and wherein training the at least one machine learning model comprises using one or more text clustering techniques to generate one or more clusters among the at least a portion of the one or more similar data columns.

8. The computer-implemented method of claim 7, further comprising:
determining one or more cluster labels based at least in part on the one or more generated clusters;
deriving one or more word embeddings for each of the one or more cluster labels; and
generating a single unified label embedding vector based at least in part on aggregating the derived word embeddings.

9. The computer-implemented method of claim 1, wherein performing one or more automated actions comprises outputting corresponding portions of the standardized data to the respective ones of the multiple clients.

10. The computer-implemented method of claim 1, wherein software implementing the method is provided as a service in a cloud environment.

11. A computer program product comprising a computer readable storage medium having program instructions embodied therewith, the program instructions executable by a computing device to cause the computing device to:
obtain multiple datasets from multiple clients in accordance with one or more data privacy techniques;
determine one or more similar data columns across at least a portion of the multiple datasets;
generate one or more column labels for the one or more similar data columns;
standardize at least a portion of data within the one or more similar data columns by processing the one or more generated column labels using at least one federated learning technique; and
perform one or more automated actions based at least in part on results of the standardizing of the at least a portion of data within the one or more similar data columns.

12. The computer program product of claim 11, wherein determining similar data columns comprises identifying the one or more similar data columns across at least a portion of the multiple datasets using one or more graph node anchoring techniques.

13. The computer program product of claim 12, wherein using one or more graph node anchoring techniques comprises, for each of the multiple datasets, constructing a graph using at least a portion of available sensitive data contained therein, and wherein in constructing the graph, each node of the graph represents a column in the given dataset, and each edge weight represents a correlation among pairs of columns in the given dataset.

14. The computer program product of claim 13, wherein using one or more graph node anchoring techniques comprises mapping one or more nodes from one of the constructed graphs to one or more nodes of at least one other of the constructed graphs by leveraging graph connectivity structure information.

15. The computer program product of claim 11, wherein processing the one or more generated column labels using at least one federated learning technique comprises learning feature name standardization across at least a portion of the multiple datasets by utilizing one or more feature label embedding techniques and based at least in part on the one or more generated column labels.

16. The computer program product of claim 15, wherein learning feature name standardization across at least a portion of the multiple datasets comprises training at least one machine learning model, using values in at least a portion of the one or more similar data columns, to predict a name of the given data column and at least one corresponding embedding vector of the given data column.

17. The computer program product of claim 16, wherein the values comprise text, and wherein training the at least one machine learning model comprises using one or more text clustering techniques to generate one or more clusters among the at least a portion of the one or more similar data columns.

18. The computer program product of claim 17, wherein the program instructions executable by the computing device further cause the computing device to:
determine one or more cluster labels based at least in part on the one or more generated clusters;
derive one or more word embeddings for each of the one or more cluster labels; and
generate a single unified label embedding vector based at least in part on aggregating the derived word embeddings.

19. The computer program product of claim 11, wherein performing one or more automated actions comprises outputting corresponding portions of the standardized data to the respective ones of the multiple clients.

20. A system comprising:
a memory configured to store program instructions; and
a processor operatively coupled to the memory to execute the program instructions to:
obtain multiple datasets from multiple clients in accordance with one or more data privacy techniques;
determine one or more similar data columns across at least a portion of the multiple datasets;
generate one or more column labels for the one or more similar data columns;
standardize at least a portion of data within the one or more similar data columns by processing the one or more generated column labels using at least one federated learning technique; and
perform one or more automated actions based at least in part on results of the standardizing of the at least a portion of data within the one or more similar data columns.
